(19) United States
(12) Patent Application Publication
(10) Pub. No.: US 2025/0144513 A1
(43) Pub. Date: May 8, 2025

(54) CAPACITIVE JOYSTICK, GAME CONTROLLER AND GAME CONTROL METHOD

(71) Applicant: DASHINE ELECTRONICS CO., LTD, Shenzhen (CN)

(72) Inventor: Bintao GUO, Shenzhen (CN)

(21) Appl. No.: 19/015,933

(22) Filed: Jan. 10, 2025

Related U.S. Application Data
(63) Continuation of application No. PCT/CN2024/121638, filed on Sep. 27, 2024.

(30) Foreign Application Priority Data
Sep. 28, 2023 (CN) 202311283160.7

(51) Int. Cl. A63F 13/24; A63F 13/214; G06F 3/044

(52) U.S. Cl. CPC A63F 13/24; A63F 13/214; G06F 3/044

(57) ABSTRACT

The present application discloses a capacitive joystick, a game controller with the capacitive joystick, and a game control method. In the capacitive joystick, the joystick assembly has a control end and at least one output end, and the output end is connected to a rotating shaft. The capacitive sensing assembly includes a rotating plate, a metal sheet and a PCB board that are spaced apart from each other and form a capacitive field. The rotating plate rotates with the rotating shaft and changes the capacitance value between the metal sheet and the PCB board. The PCB board sends the capacitance data including the capacitance value to the main circuit board.

### CROSS-REFERENCE TO RELATED APPLICATION

The present application is a continuation of PCT application no. PCT/CN2024/121638, filed on Sep. 27, 2024, which is based on and claims the priority benefits of China application No. 202311283160.7, filed on Sep. 28, 2023. The entireties of PCT application no. PCT/CN2024/121638 and China application No. 202311283160.7 are hereby incorporated by reference herein and made a part of this specification.

### TECHNICAL FIELD

The present application relates to the field of electronic devices, and, more particularly, to a capacitive joystick, a game controller, and a game control method.

### BACKGROUND ART

With the improvement of living standards, the frequency of using a joystick in a game is increasing. The recognition of joystick movements is a key technical feature in a game controller, for which a thin film resistance joystick are widely used. In related technologies, conventional thin-film resistive joysticks have a short service life due to limitation present in manufacturing process. Further, when using the thin film resistive joystick, the problem of carbon particle adsorption caused by the friction between an elastic piece and the thin film resistor can easily lead to a problem of mouse drift, resulting in poor performance stability. To solve the above problems, a Hall joystick is developed on the market, but it has high power consumption, not suitable for low-power products.

### SUMMARY

In order to overcome the shortcomings present in existing technologies, the present application provides a capacitive joystick, a game controller, and a game control method.

The technical solution of the present application is as follows:

On the one hand, a capacitive joystick is provided, including:
a joystick assembly, wherein the joystick assembly has a control end and at least one output end, and the output end is connected to a rotating shaft;
a capacitive sensing assembly, including a rotating plate and a metal sheet and a PCB board arranged at intervals to form a capacitive field, the rotating plate is used to rotate with the rotating shaft and change the capacitance value between the metal sheet and the PCB board, the PCB board is connected to the main circuit board and sends capacitance data including the capacitance value to the main circuit board, and the main circuit board calculates and outputs data changes based on the change in capacitance value.

Optionally, the PCB board is provided with a conductive sheet, which correspond to the positions of the metal sheet.

Optionally, the capacitive sensing assembly includes a housing, wherein the metal sheet, the PCB board, and the rotating plate are all located within a cavity inside the housing.

Furthermore, the housing includes a base and a side cover that is detachably connected to the base. The metal sheet, the PCB board, and the rotating plate are all located within the cavity enclosed by the base and the side cover.

Furthermore, one of the base and the side cover is provided with a buckle, and the other of the base and the side cover is provided with a groove. The buckle is connected to the groove, allowing the base to be detachably connected to the side cover.

Optionally, the joystick assembly includes a joystick body and a rotating portion, one end of the joystick body is the control end, the other end of the joystick body extends into the rotating portion, and the rotating portion has the output end.

Optionally, the main circuit board is provided with a capacitor chip, which is electrically connected to the PCB board. The capacitor chip is used to receive the capacitance data of the PCB board and convert it to obtain the position information of the joystick body.

Optionally, the capacitive joystick further includes a switch component, which is electrically connected to the main circuit board.

On the other hand, a game controller is provided, including a controller body, wherein the controller body is provided with the aforementioned capacitive joystick.

On the other hand, a game control method is provided based on the aforementioned capacitive joystick, including the following steps:
when the rod body of the joystick assembly moves, the rotating plate in the capacitive sensing assembly is controlled to rotate by the output end of the joystick assembly, causing a change in the capacitance value between the metal sheet and the PCB board; and
the main circuit board obtains the capacitance data output by the PCB board and obtains the position information of the control end in the joystick assembly.

According to the present application of the above scheme, the two output ends of the joystick assembly in different directions are respectively connected to the corresponding capacitive sensing assemblies. The two capacitive sensing assemblies respectively obtain the input signals of the control ends in the joystick assembly in two different directions. The main circuit board receives the capacitance data of the two capacitive sensing assemblies and obtains the position information of the control ends in the joystick assembly.

The beneficial effects of the present application based on the above scheme are as follow.

The present application generates capacitance signal output through non-contact method between the metal sheet and the PCB board, which greatly increases the service life compared to traditional contact output method, and solves the problem of wear caused by carbon brush contact friction in traditional methods. After wear, residue will be left at the contact area, causing unstable contact and drift.

In addition, the present application achieves synchronous rotation of the joystick through a rotating plate, which can change the capacitance value between the metal sheet and the PCB board. The detection of capacitance changes is more accurate, improving the detection accuracy of joystick motion. Meanwhile, the present application occupies minimal space and is not limited by the installation space of the joystick device. It can be implemented and promotes the promotion and application of capacitive joysticks.

### BRIEF DESCRIPTION OF THE DRAWINGS

FIG. 1 is a schematic structural diagram of a capacitive joystick according to the present application;

FIG. 2 is a schematic diagram of a capacitive joystick according to the present application from another perspective;

FIG. 3 is an exploded structural view of a capacitive joystick according to the present application;

FIG. 4 is an exploded view of a capacitive joystick according to the present application from another perspective;

FIG. 5 is a schematic position diagram of a rotating plate and a metal sheet when a joystick body swings left in a first direction in the present application;

FIG. 6 is a schematic position diagram of a rotating plate and a metal sheet when a joystick body swings right in the first direction in the present application; and

FIG. 7 shows a game control flowchart when the joystick body of the present application swings.

### DETAILED DESCRIPTION

The following provides further description of the present application in connection with the accompanying drawings and embodiments.

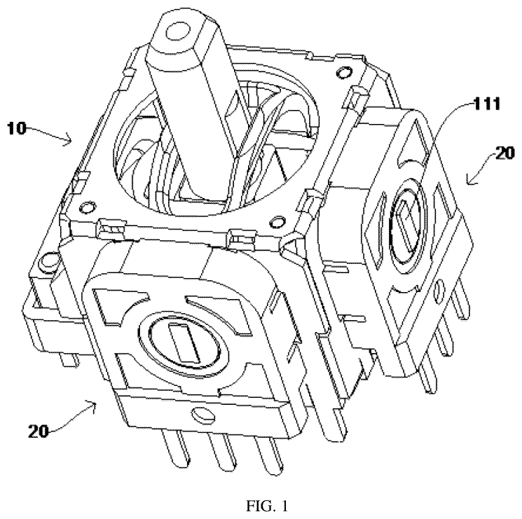

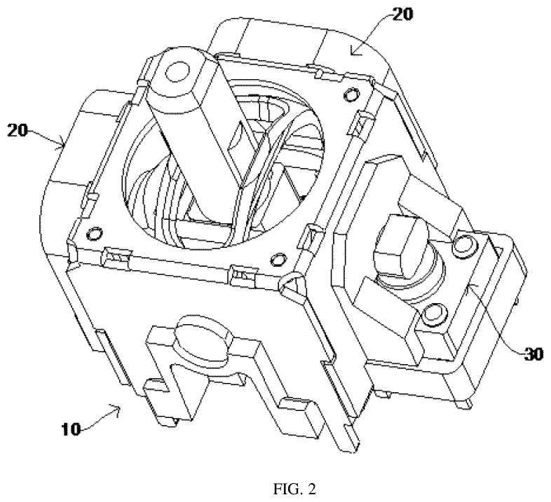

As shown in FIGS. 1 to 6, the present application provides a game controller to overcome the shortcomings present in traditional thin film resistive joysticks, such as short lifespan, poor performance stability due to drift, and high power consumption of Hall joysticks. The game controller includes a controller body, which is provided with a capacitive joystick. This capacitive joystick is based on non-contact capacitive joystick, which reduces the lifespan reduction and drift caused by wear due to non-contact connection. In addition, change in the position of the joystick is obtained through the change in capacitance value, improving the detection accuracy of joystick position.

The capacitive joystick includes a joystick assembly 10 and a capacitive sensing assembly 20. The joystick assembly 10 is used to obtain human operation actions and output mechanical action signals based on the actions. The capacitive sensing assembly 20 is used to output capacitive signals based on the mechanical action signals of the joystick assembly 10 and send them to a main circuit board for data analysis to obtain a position signal of the joystick.

### 1. Joystick Assembly

The joystick assembly 10 has a control end and at least one output end, which is connected to a rotation shaft 111. The control end is used to receive human control, and the output end is used to output mechanical action signals.

Specifically, the joystick assembly 10 includes a housing, a joystick body 11 and a rotating portion assembled on the housing. The housing serves as a support foundation for the entire joystick assembly 10 and can be directly installed on the main circuit board or other positions of the game controller. Specifically, when the joystick assembly 10 is directly installed on the main circuit board, the housing of the joystick assembly 10 is provided with mounting feet, and mounted on the main circuit board via the mounting feet.

The joystick body 11 has at least two ends, one of which is the control end for receiving human control actions, and the other of which extends into the housing and is connected to the rotating portion. The rotating portion is used to control the other end of the joystick body 11 and output mechanical action signals. The rotating portion has an output end for controlling the capacitive sensing assembly 20.

In a preferred embodiment, due to the fact that the joystick body 11 in the joystick assembly 10 is mostly implemented in a fully rotating manner, the rotating portion in the present application includes a first rotating shaft and a second rotating shaft. The second rotating shaft sleeve is arranged inside the first rotating shaft to form a universal joint, and the joystick body 11 is connected to the second rotating shaft through the first rotating shaft.

In order to enable the joystick body 11 to rotate in all directions, a first swing track is provided in the first rotating shaft, and a second swing track is provided in the second rotating shaft, and the first swing track intersects with the second swing track (Optionally in two perpendicular intersecting planes). The first rotating shaft has a first shaft, which is hinged to the housing and used for swinging the first rotating shaft, the second rotating shaft, and the joystick body 11 in a first plane. The second rotating shaft has a second shaft, which passes through the first rotating shaft and is hinged to the housing for swinging the second rotating shaft and the joystick body 11 in a second plane. The present application achieves an all-round rotation of the joystick body 11 through the mutual cooperation between the first rotating shaft, the second rotating shaft, and the joystick body 11 and the housing.

Of course, in other embodiments, the joystick body 11 can also achieve all-round rotation through rotating portions of other structures, which is not limited in the present application.

In addition, the present application can also meet the requirement of the joystick body 11 rotating in one plane. Here, only one universal joint structure is used for the rotating portion, and the joystick body 11 can rotate within the swing track of the universal joint to achieve the output of action of the rotation shaft 111 of the joystick body 11. Of course, the joystick body 11 can also be directly configured to form a rotation shaft 111, which serves as the output end of the mechanical action signal, meaning that the joystick body 11 has both a control end and an output end.

The joystick assembly 10 also includes a resetting component located inside the housing, which is used to provide a restoring force for the joystick body 11. Specifically, there is a bottom plate below the housing, and the housing is connected to the bottom plate by interlocking (not shown in the figure). One end of the resetting component is in contact with the bottom plate of the housing, and the other end is in contact with the joystick body 11, so that when the joystick body 11 is subjected to downward pressure, it drives the resetting component to compress. When the joystick body 11 is free of downward pressure, the resetting component drives the joystick body 11 to reset. A preferred resetting component can be a spring.

### 2. Capacitive Sensing Assembly

There is at least one capacitive sensing assembly 20 in the present application, and the capacitive sensing assembly 20 is connected to the rotation shaft 111 of the joystick assembly 10. When two or more capacitive sensing assemblies 20 are set, each capacitive sensing assembly 20 is respectively connected to one rotation shaft 111 of the joystick assembly 10.

Each of the capacitive sensing assembly 20 includes a rotating plate 24, as well as metal sheets 23 and a PCB board 25 that are spaced apart from each other and form a capacitive field. The metal sheet 23 and the PCB board 25 form a capacitive field spaced apart from each other. The rotating plate 24 is connected to the rotation shaft 111 and is located between the metal sheet 23 and the PCB board 25. Under normal conditions, the capacitance field between metal sheet 23 and PCB board 25 is separated by rotating plate 24. However, as rotating plate 24 rotates with the rotation shaft 111 and changes the overlapping area between metal sheet 23 and PCB board 25, the capacitance value between them can be altered. By detecting the capacitance value between the metal sheet 23 and the PCB board 25, the rotation status of the rotating plate 24 can be obtained.

The rotating plate 24 includes a rotating shaft 241 and a blocking plate 242. The rotating shaft 241 is connected to the rotation shaft 111, and the rotating shaft 241 is used to receive the driving force of the rotation shaft 111 to drive the blocking plate 242 to rotate. The blocking plate 242 is used to shield the metal sheet 23 and the PCB board 25 to achieve a change in the capacitance field between them. Optionally, the rotating shaft 241 has a shaft hole 243, and is connected to the rotation shaft 111 through the shaft hole 243. The shaft hole 243 can be a non-circular hole, so that when the rotation shaft 111 rotates, it drives the rotating shaft 241 to rotate. The rotating plate 24 in the present application optionally includes an insulating material, such as plastic, ceramic, etc., so as to avoid affecting the capacitance field between the metal sheet 23 and the PCB board 25.

In addition, the PCB board 25 is connected to a main circuit board, so that after measuring the capacitance value between PCB board 25 and the metal sheet 23, the capacitance data (or capacitance signal) including the capacitance value is sent to the main circuit board. The main circuit board calculates and outputs the data change (including voltage and current changes) based on the change in capacitance value. Specifically, the main circuit board can analyze the capacitance data to obtain the rotation information of the rotating plate 24, that is, the rotation information of the joystick. In order to achieve signal conversion of the position of the joystick body 11, a capacitor chip is provided on the main circuit board in the present application. The capacitor chip is used to receive the capacitor signal of the PCB board 25 and convert it to obtain the position information of the joystick body 11.

In the present application, the capacitive sensing assembly 20 includes a housing, which is used to provide the hardware support foundation for the entire capacitive sensing assembly 20. The metal sheet 23, PCB board 25, and rotating plate 24 are all located in a cavity inside the housing. Specifically, the metal sheet 23 and the PCB board 25 are fixed inside the housing, and the rotating plate 24 is sleeved inside the housing and rotates around a central axis of the rotation shaft 111.

In order to achieve convenient assembly of the capacitive sensing assembly 20, the housing includes a base 21 and a side cover 22 that can be detachably connected to the base 21. The metal sheet 23, the PCB board 25, and the rotating plate 24 are all located in the cavity surrounded by the base 21 and the side cover 22. Specifically, the housing has a first installation space, and the side cover 22 has a second installation space. The first installation space corresponds to the second installation space, forming a cavity that accommodates the metal sheet 23, the PCB board 25, and the rotating plate 24. In the connection structure between the base 21 and the side cover 22, one of the base 21 and the side cover 22 is provided with a buckle, and the other of the base 21 and the side cover 22 is provided with a groove. The buckle is connected to the groove, so that the base 21 and the side cover 22 can be detachably connected (in this embodiment, a side cover buckle 221 is provided on the side cover 22).

In order to achieve the rotation control of the rotating plate 24 and avoid the influence on the capacitive sensing assembly 20 during the rotation process, the base 21 in the present application is provided with a base perforation 211, and the metal sheet 23 is provided with a middle metal sheet groove 231 in the middle. The rotation shaft 111 passes through the base perforation 211 and the middle metal sheet groove 231 in sequence and is connected to the shaft hole 243 located on the rotating plate 24 to drive the rotating plate 24 to rotate.

Since the capacitance field is formed by two opposing conductive structures, a conductive sheet is provided on the PCB board 25 corresponding to the position of the metal sheet 23 in the present application. The conductive sheet corresponds to the position of the metal sheet 23 to form the capacitance field. The circuit on the PCB board 25 is used to receive the capacitance value between the conductive sheet and the metal sheet 23 and generate a capacitance signal. The conductive pads here are conductive contacts, solder pads, or gold finger structures provided on the PCB board 25. By integrating the conductive pads on the PCB board 25, the difficulty of processing the PCB board 25 is reduced.

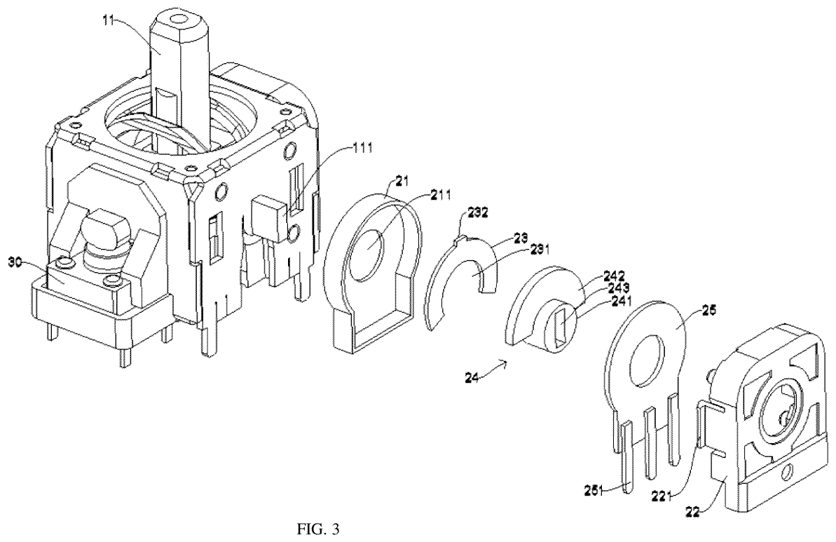

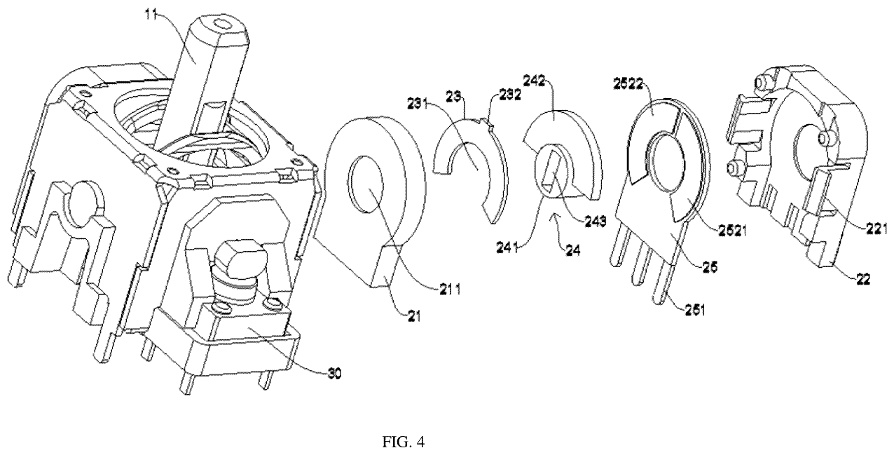

In one embodiment, both the conductive sheet and the metal sheet 23 are fan-shaped, and the blocking plate 242 of the rotating plate 24 is fan-shaped. In another embodiment, both the conductive sheet and the metal sheet 23 are fan-shaped, and the blocking plate 242 of the rotating plate 24 is fan-shaped or annular fan-shaped. In the embodiments shown in FIGS. 3 and 4, both the conductive sheet and the metal sheet 23 are in a fan-shaped shape, and the corresponding central angle of the fan-shaped shape is greater than 180°. The blocking plate 242 of the rotating plate 24 is in a fan-shaped shape, and the corresponding central angle of the fan-shaped shape is 180°.

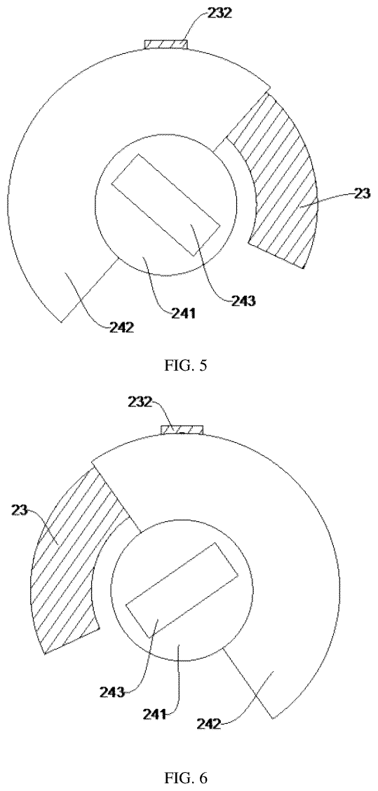

As shown in FIGS. 5 and 6, due to the possibility of movement in both left and right directions when the joystick body 11 rotates from its initial position, considering only the change in capacitance between the metal sheet 23 and the conductive plate is not sufficient to determine the motion state of the joystick body 11. Therefore, in an optional embodiment, the conductive plates include a first conductive plate 2521 and a second conductive plate 2522 that are spaced apart from each other. The first conductive plate 2521 and the second conductive plate 2522 cooperate with each other for identifying the direction and angle of rotation of the rotating plate 24.

Specifically, when the capacitance between the first conductive plate 2521 and the metal sheet 23 decreases (or remains unchanged) relative to the original position, and the capacitance between the second conductive plate 2522 and the metal sheet 23 increases, the rotating plate 24 rotates in the direction of the first conductive plate 2521. When the capacitance between the first conductive plate 2521 and the metal sheet 23 increases and the capacitance between the second conductive plate 2522 and the metal sheet 23 decreases (or remains unchanged) relative to the original position, the rotating plate 24 rotates in the direction of the second conductive plate 2522.

Therefore, the PCB board 25 in the present application not only outputs the capacitance value between the metal sheet 23 and the PCB board 25, but also outputs the change in capacitance value to identify the direction of rotation of the rotating plate 24. That is, when the PCB board 25 outputs a capacitance value with a first change amount (an increase in the first capacitance field capacity and a decrease in the second capacitance field capacity), it indicates that the rotating plate 24 is rotating to the left, and the magnitude of the rotation of the rotating plate 24 is indicated by the value of the first change amount. When PCB board 25 outputs a capacitance value with a second variation (decrease in first capacitance field capacity, increase in second capacitance field capacity), it indicates that rotating plate 24 is rotating to the right, and the magnitude of rotation of rotating plate 24 is indicated by the value of the second variation. Correspondingly, PCB pin 251 of PCB board 25 includes a first pin, a second pin, and a common pin. The data of the first capacitance field corresponding to the first conductive plate 2521 is output between the first pin and the common pin, and the data of the second capacitance field corresponding to the second conductive plate 2522 is output between the second pin and the common pin. By the coordination of the three pins, an analog signal is output to the circuit board to achieve the position information of the joystick body 11 output from PCB board 25, including direction information and specific position information.

Optionally, in the embodiments shown in FIGS. 5 and 6, the shielding area of the rotating plate 24 is smaller than the overlapping area between the metal sheet 23 and the PCB board 25, so that the PCB board 25 outputs a non-zero capacitance signal value in the initial state.

The metal sheet 23 is also provided with a protruding metal sheet positioning portion 232, which enables the positioning of metal sheet 23 corresponding to that of the PCB board 25, and also facilitates the fixation of metal sheet 23 on the housing.

In a preferred embodiment, a joystick assembly 10 is provided with two capacitive sensing assemblies 20, and these two capacitive sensing assemblies 20 are respectively connected to the two rotation shafts 111 of the joystick assembly 10, for detecting the rotational information of the joystick body 11 in the X and Y axes.

### 3. Switch Component

The capacitive joystick further includes a switch component 30, which is electrically connected to the main circuit board. The switch component 30 outputs digital signals to the main circuit board to achieve switch control. In the present application, the switch component 30 includes a button (which can be a physical button or a pressure sensing button) and an assembling portion. The button is installed on the housing of the joystick assembly 10 through the assembling portion, so that when the joystick body 11 is pressed down, the button is pressed, and the Z-axis direction sensing signal is output to the main circuit board through the button.

In order to avoid the influence of switch component 30 on the mechanical action signal output of the joystick assembly 10, the housing of joystick assembly 10 is provided with space for the up and down movement of the rotation shaft 111.

The switch component 30 has connection pins, and is installed on the main circuit board through the connection pins to achieve signal transmission.

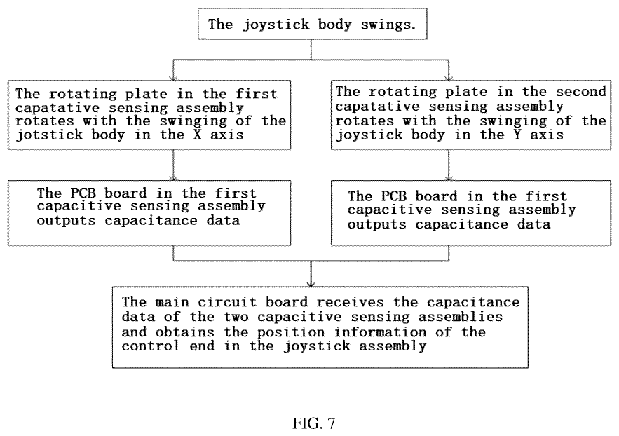

As shown in FIG. 7, based on the game controller and capacitive joystick mentioned above, the present application further provides a game control method, which detects the action of the joystick body 11 in the joystick assembly 10 through the capacitive sensing assembly 20, and thereby obtains the position information of the joystick body 11.

The game control method includes the following steps:

(1) When the body of joystick assembly 10 moves, i.e. joystick body 11 is controlled by the user's hand to swing in one direction (i.e. X-axis) or two directions (i.e. Y-axis).

(2) The rotating plate 24 in the capacitive sensing assembly 20 is controlled to rotate by the output end of the joystick assembly 10, causing a change in the capacitance value between the metal sheet 23 and the PCB board 25. Specifically, when the joystick body 11 rotates, the rotation shaft 111 also rotates, and the rotating plate 24 rotates with the rotation shaft 111. At this time, the rotating plate 24 rotates between the metal sheet 23 and the PCB board 25, causing the exposed area of the metal sheet 23 relative to the rotating plate 24 to increase/decrease, thereby changing the relative overlapping area between the metal sheet 23 and the PCB board 25.

For example, during use, moving the joystick body 11 to the left causes the rotating plate 24 to deflect to the left, resulting in an increase in the shielding area on the left side of the metal sheet 23 (a decrease in the exposed area) and a decrease in the shielding area on the right side of the metal sheet 23 (an increase in the exposed area). This leads to a decrease in the overlapping area of the left side of the metal sheet 23 relative to the PCB board 25, and an increase in the overlapping area of the right side of the metal sheet 23 relative to the PCB board 25, and vice versa.

(3) The obstruction of the rotating plate 24 causes a change in the overlapping area between the metal sheet 23 and the PCB board 25, resulting in a change in the output capacitance value of the PCB board 25 (including changes in the magnitude and direction of the capacitance value), thereby obtaining specific capacitance value information.

The capacitance data output by PCB board 25 includes the capacitance value between the metal sheet 23 and the PCB board 25, and the capacitance chip calculates the change based on this capacitance value. For example, when the joystick body 11 is moved to the left to change its position, the joystick body 11 drives the rotating plate 24 to rotate to the left, thereby increasing the shielding area between the metal sheet 23 and the first conductive plate 2521. At this time, the capacitance value between the metal sheet 23 and the first conductive plate 2521 is A1, and the capacitance value A1 decreases relative to the initial value A0, with a change value Δ a (where Δa=A0−A1), and Δa<0. Then, the PCB board 25 outputs information such as “capacitance value A1”, “change value Δ a”, and “Δ a<0”.

(4) The main circuit board obtains the capacitance data output from PCB board 25, compares it with the capacitance information stored in advance at the original position, rotates the rotating plate 24 in the direction and angle of rotation, and then obtains the position information of the control end in joystick assembly 10 (i.e. the swing direction and swing angle of joystick body 11).

In the present application, a capacitor chip is installed on the main circuit board, which is electrically connected to the PCB board 25. The capacitor chip is used to receive the capacitor data output by the PCB board 25 and convert it to obtain the position information of the joystick body 11.

The above steps (2) to (3) are the signal reception, analysis, and output process of a capacitive sensing assembly 20. When two capacitive sensing assemblies 20 are used, the two different output axes of the joystick assembly 10 are respectively connected to the corresponding capacitive sensing assemblies 20. The two capacitive sensing assemblies 20 respectively obtain input signals from the control end of the joystick assembly 10 in two different directions (i.e. X-axis and Y-axis). The main circuit board receives the capacitance data of the two capacitive sensing assemblies 20 and obtains the position information of the control end in the joystick assembly 10. Two capacitive sensing assemblies 20 synchronize the steps (2) to (3) mentioned above. Both capacitive sensing assemblies 20 output capacitance change information, and the main circuit board can determine the comprehensive rotation information of joystick assembly 10 in the X and Y directions.

The present application generates signal output through non carbon brush contact, which greatly increases the lifespan of the previous contact output and solves the problem of wear suffered by traditional carbon brush contact friction, resulting in residue at the contact site causing unstable contact and drift. Compared to existing non-contact signal outputs, it occupies minimal space and is not limited by installation space. At the same time, by rotating the plate 24 to block between the metal sheet 23 and the PCB board 25, the capacitance detection can be more accurate and the signal detection accuracy can be high.

It should be understood that for those skilled in the art, improvements or transformations can be made based on the above description, and all such improvements and transformations should fall within the scope of protection of the claims attached to the present application.

The present application is described exemplarily in combined with the accompanying drawings. Obviously, the implementation of the present application is not limited by the above methods. As long as various improvements are made by adopting the method concept and technical solution of the present application, or directly applying the concept and technical solution of the present application to other occasions without improvement, it is within the scope of protection of the present application.

### LISTING OF REFERENCE SIGNS

10. Joystick assembly;
11. Joystick body;
111. Rotating shaft;
20. Capacitive sensing assemblies;
21. Base;
211. Base perforation;
22. Side cover;
221. Side cover buckle;
23. Metal sheet;
231. Middle metal sheet groove;
232. Metal sheet positioning portion;
24. Rotating plate;
241. Rotating shaft;
242. Blocking plate;
243. Shaft hole;
25. PCB board;
251. PCB pins;
2521. First conductive sheet;
2522. Second conductive sheet;
30. Switch components.

What is claimed is:

1. A capacitive joystick, comprising
a joystick assembly, wherein the joystick assembly has a control end and at least one output end, and the at least one output end is connected to a rotating shaft; and
a capacitive sensing assembly, comprising a rotating plate and a metal sheet and a printed circuit board (PCB) arranged at intervals to form a capacitive field, wherein the rotating plate is used to rotate with the rotating shaft and change a capacitance value between the metal sheet and the PCB, the PCB is connected to a main circuit board and sends capacitance data comprising the capacitance value to the main circuit board, and the main circuit board calculates and outputs data changes based on the change in the capacitance value.

2. The capacitive joystick according to claim 1, wherein a conductive sheet is provided on the PCB, and a position of the conductive sheet corresponds to that of the metal sheet.

3. The capacitive joystick according to claim 1, wherein the capacitive sensing assembly comprises a housing, and the metal sheet, the PCB, and the rotating plate are all located in a cavity inside the housing.

4. The capacitive joystick according to claim 3, wherein the housing comprises a base and a side cover detachably connected to the base, and the metal sheet, the PCB, and the rotating plate are all arranged in the cavity surrounded by the base and the side cover.

5. The capacitive joystick according to claim 4, wherein one of the base or the side cover is provided with a buckle, and the other of the base or the side cover is provided with a groove, and the buckle is connected to the groove, so that the base and the side cover are detachably connected with each other.

6. The capacitive joystick according to claim 1, wherein the joystick assembly comprises a joystick body and a rotating portion, a first end of the joystick body is the control end, a second end of the joystick body extends into the rotating portion, and the rotating portion has the at least one output end.

7. The capacitive joystick according to claim 6, wherein a capacitive chip is provided on the main circuit board, the capacitive chip is electrically connected to the PCB, and the capacitive chip is used to receive the capacitance data of the PCB and convert the capacitance data to obtain a position information of the joystick body.

8. A game controller, comprising a controller body, wherein the controller body is provided with the capacitive joystick according to claim 1.

9. A game control method based on the capacitive joystick according to claim 1, comprising the following steps:
when a rod body of the joystick assembly moves, the rotating plate in the capacitive sensing assembly is controlled to rotate by the at least one output end of the joystick assembly, causing the change in the capacitance value between the metal sheet and the PCB; and
the main circuit board obtains the capacitance data output by the PCB and obtains position information of the rod body in the joystick assembly.

10. The game control method according to claim 9, wherein two non-coaxial output ends of the joystick assembly are respectively connected to corresponding capacitive sensing assemblies, the two capacitive sensing assemblies respectively obtain input signals of the two non-coaxial output ends in the joystick assembly, the main circuit board receives the capacitance data of the two capacitive sensing assemblies and obtains position information of the control end in the joystick assembly.
